(19) United States
(12) Patent Application Publication
(10) Pub. No.: US 2026/0000225 A1
(43) Pub. Date: Jan. 1, 2026

(54) HOG WIRE HANGERS

(71) Applicant: Todd Reams, Clinton, WA (US)

(72) Inventor: Todd Reams, Clinton, WA (US)

(21) Appl. No.: 18/758,319

(22) Filed: Jun. 28, 2024

(51) Int. Cl. A47G 7/04; A01K 3/00; A47G 29/00; F16B 45/00; F16M 13/02

(52) U.S. Cl. CPC A47G 7/044; F16B 45/012; F16M 13/022; A01K 3/00; A47G 29/00

(57) ABSTRACT

The present disclosure relates to hog wire hangers for organizing and supporting various outdoor decor e.g. planters, bird houses, lights, banners, bird feeders, outdoor lanterns, and others on commonly used hog wire fencing, or deck railings. The hog wire hanger includes an affixing portion for detachably fixing at a selected grid of a hog wire panel. The affixing portion includes a base member, a pair of vertical members each extending vertically upward from a first end, and a second end of the base member. The hog wire hanger further includes a pair of outwardly extending members spaced apart from each other. Each of the outwardly extending members extended from the ends of the pair of vertical members. The hog wire hanger further includes a retaining portion attached to the ends of the pair of outwardly extending members retaining a selected outdoor décor or a mobile instrument.

### FIELD OF THE INVENTION

The present invention relates generally to hangers in general, and particularly, to structures for supporting outdoor decors. More particularly, the present invention specifically pertains to hog wire hangers for organizing and supporting various outdoor decors including but not limited to planters, bird houses, lights, banners, bird feeders, outdoor lanterns, and others on a commonly used hog wire fencing, stairways, or deck railings. Further, certain embodiments of the proposed hog wire hangers may be useful for holding personal usable products such as mobile phones/tablets or other similar mobile instruments.

### BACKGROUND

Homeowners looking to have a deck makeover, or first-time deck builders seeking to expand their outdoor living space outward usually use easy-to-install hog wire railing panels for deck railings, stairways, and outdoor fences. The hog wire railing panels preferably feature 4-inch by 4-inch or 6-inch by 6-inch mesh or grid with either woven or welded cross points. Incredibly attractive, durable, and cost-effective, hog railing panels deliver a non-bulky deck railing option to keep the backyard and deck visibility open. The hog wire panels provide a stylish look to homes, ranches, or cabins with rustic, and western aesthetics and are less cost-effective options for the homemakers and builders.

Traditionally, it has been observed that homeowners who use hog wire railing panels for deck railings, stairways, and fences are unable to keep their outdoor living space neat. Lots of spaces around their deck or backyard are used for ornamental, environmental, and related purposes, such as for hanging items such as birdhouses, bird feeders, plants, flowers, outdoor lanterns, and other items, outside of their homes. This may render their outdoor living spaces unorganized and cluttered occupying a lot of space.

As an attempt to keep the outdoor deck organized and tidy and free up lots of ground usable space, traditionally, different kinds of hangers, planter stands and so on are used. The traditional hangers are reusable and adjustable to allow for hanging different items at different heights at different times outdoors. The planter stands help in the placement of flower pots over them. The mounting hangers that are usually used aren't simple to install and require the use of many additional tools. Further, many kinds of these hangers come apart unintentionally due to various factors and thus are unreliable. Additionally, different stands used for planters occupy significant ground spaces. Importantly, out of all of these existing solutions that exist, none of them are typically designed to be used with hog wire panels.

To address the above-mentioned issues associated with organizing and keeping the deck or outdoor living spaces free from clutter and freeing the space, the inventor herein proposes a promising solution to these issues by providing effective and easy-to-use hog wire hangers that can interlock within grids of the hog wire railing panels or grids of the fences and strongly uphold or support various kinds of outdoor decors at different distances or heights from the hog wire railing panels, stairways or fences.

### BRIEF SUMMARY

In view of the foregoing disadvantages inherent in the known types of hanger apparatuses present in the prior art, the present invention provides hog wire hangers that can be easily mounted interlocking within selected grids of the hog wire panels commonly used in decks or fences of houses. As such, the general purpose of the present invention, which will be described subsequently in greater detail, is to provide new and improved hangers that can be detachably mounted on the grids of hog wire fences, deck railing, stairways, or similar outdoor places.

To attain this, embodiments of the present invention disclose a hog wire hanger. The hog wire hanger includes an affixing portion adapted for detachably fixing at a selected grid of a hog wire panel. The affixing portion consists of a base member, a first vertical member, and a second vertical member upwardly extending from a first end and a second end of the base member. The hog wire hanger includes a pair of outwardly extending members spaced apart from each other, each of the outwardly extending members extended from an end of the first vertical member, and the second vertical member respectively.

The hog wire hanger further includes a retaining portion attached to an end of the pair of outwardly extending members for retaining outdoor décor or mobile instruments therein.

In an embodiment, the retaining portion is circular shaped defining a receiving space for accommodating the outdoor décor therein.

In an embodiment, the affixing portion is smaller than 4″ in width (W) and greater than 4″ in height (H) in order to be able to be fixed on 4″×4″ grid of the hog wire panel.

In an embodiment, each of the outwardly extending members descends downward forming substantially U-shaped curves before being extended outward from the end of the first vertical member, and the second vertical member.

In an embodiment, the retaining portion is configured as a hook member comprising a C-shaped head, and an arm interconnected to at least one of: the end of the first vertical member, and the second vertical member.

In an embodiment, the pair of outwardly extending members extended outward from the end of the first vertical member, and the second vertical member substantially forms a U-shaped structure.

In an embodiment, the C-shaped head of the hook member defines the receiving space disposed at a predefined distance from the affixing portion for accommodating the outdoor décor.

In an embodiment, the arm of the hook member is oriented substantially straight extending from the U-shaped structure.

In an embodiment, the arm of the hook member is oriented at a first predefined angle (X degrees) from the affixing portion extending from the U-shaped structure.

In an embodiment, the first portion of the arm having the C-shaped head connected thereto is curved at a second predefined angle (Y degrees) with respect to a second portion of the arm extending from the U-shaped structure.

In an embodiment, the retaining portion (106) is configured as a mounting member comprising a mount (106a) for holding the outdoor décor (502), and the arm (106b) interconnected to at least one of the end of the first vertical member (102b), and the second vertical member (102c).

In an embodiment, the first portion of the arm having the mount configured thereon is inwardly bent and is oriented perpendicular to the mount while the second portion of the arm is oriented at the first predefined angle (X degrees) from the affixing portion.

In an embodiment, each of the outwardly extending members descends downward at a third predefined angle (Z degrees) and forms substantially V-shaped curves before being extended outward from the end of the first vertical member, and the second vertical member.

In an embodiment, the retaining portion 106 is made substantially straight and connects the pair of outwardly extending members 104a, 104b. The retaining portion 106 connects the pair of outwardly extending members 104a, 104b by being elevated by a certain distance.

Accordingly, the proposed invention provides a hanging apparatus that can be used for hanging various outdoor décors from hog wire grids of the hog wire railing panels stairways, or fences.

It is an object of the present invention to provide hog wire hangers for hanging various outdoor décors from hog wire grids of the hog wire railing panels or fences, thereby saving usable spaces all around the decks and the backyard.

It is an object of the present invention to provide hog wire hangers preferably lightweight and simple in design to make the process of hanging such outdoor items easy, and yet strong enough to hold a significant weight.

It is an object of the present invention to provide hog wire hangers simple to install and use without requiring the use of many additional tools. The proposed hog wire hangers are typically positionable being interlocked within the grids of the hog wire panels holding outdoor items.

It is an object of the present invention to provide hog wire hangers that do not require routine inspection to ensure their dislodgement from the grids of the grids of the hog wire panels.

These and other features and advantages of the present invention will become apparent from the detailed description below, in light of the accompanying drawings.

### BRIEF DESCRIPTION OF THE ACCOMPANYING DRAWINGS

The novel features which are believed to be characteristic of the present invention, as to its structure, organization, use, and method of operation, together with further objectives and advantages thereof, will be better understood from the following drawings in which a presently preferred embodiment of the invention will now be illustrated by way of example. It is expressly understood, however, that the drawings are for illustration and description only and are not intended as a definition of the limits of the invention. Embodiments of this invention will now be described by way of example in association with the accompanying drawings in which:

FIGS. 1-2 is a front perspective view, and a front view of a hog wire hanger for holding planters, according to an exemplary embodiment of the present invention.

FIG. 3 is a front view of the hog wire hanger of FIGS. 1-2 with a wider neck.

FIGS. 4-5 is a front perspective view and a front view of the hog wire hanger of FIG. 1-2 with a further wider neck.

FIGS. 6-7 is a front perspective view, and a side view of a horizontal hog wire hanger, according to an embodiment of the present invention.

FIGS. 8-9 are further perspective views of the horizontal hog wire hanger of FIG. 6, according to yet another embodiment.

FIGS. 10-11 is a front perspective view, and a side view of a vertical hog wire hanger, according to an embodiment of the present invention.

FIG. 12 is a front perspective view of a hog wire hanger useful for mounting birdhouses, according to an embodiment of the present invention.

FIGS. 13-15 is a front perspective view, a front view, and a side view of a hog wire hanger useful for holding personal usable products such as mobile phones/tablets, according to another embodiment of the present invention.

FIG. 16 shows the hog wire hanger of FIG. 13 in use.

FIGS. 17-20 shows various hog wire hangers of FIGS. 1,6,10,12 in use.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the figures may be exaggerated, relative to other elements, to improve the understanding of the present invention. There may be additional components described in the foregoing application that are not depicted in one of the described drawings. In the event such a component is described, but not depicted in a drawing, the absence of such a drawing should not be considered as an omission of such design from the specification.

Before describing the present invention in detail, it should be observed that the present invention utilizes a combination of components or set-ups, which constitutes hog wire hangers for organizing and supporting various outdoor decors including but not limited to planters, bird houses, lights, banners, bird feeders, outdoor lanterns, and others on commonly used hog wire fencing, stairways or deck railings. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. Unless stated otherwise, terms such as “first” and “second” are used to arbitrarily distinguish between the elements. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the invention to the precise form disclosed. Modifications and variations are possible considering the above teachings or may be acquired from practicing the invention, without departing from the breadth or scope.

Hog wire was originally designed to confine hogs and pigs within a pen or pasture. But over time it has become popular and remains a go-to fencing option for fencing in other farm animals and domestic pets. Nowadays, besides being used as a fencing medium, hog wire panels are becoming a popular building product that offers a unique and decorative railing option for consumers and professional contractors alike. These panels are renowned for their strength and durability, affordable price, ease of transport and installation, and long-lasting nature. The hog wire panels can be used in a wide range of applications, including deck rails, stairways, fences, and more. As known, the hog wire panels are constructed from high-quality sturdy steel wires that are welded together to create a durable and attractive design. The steel wires are galvanized to protect against rust and corrosion, ensuring that the panels will withstand the elements and continue to look great for years to come. Ideally, the hog wire panels come in different spacing sizes. The spacing determines how big the rectangular openings are. For example, a 4″ mesh hog wire will have 4″×4″ openings. The embodiments of the present invention provide hog wire hangers that can be detachably hung on these openings and hold/support various outdoor decors, e.g. planters, bird houses, lights, banners, bird feeders, outdoor lanterns, and others.

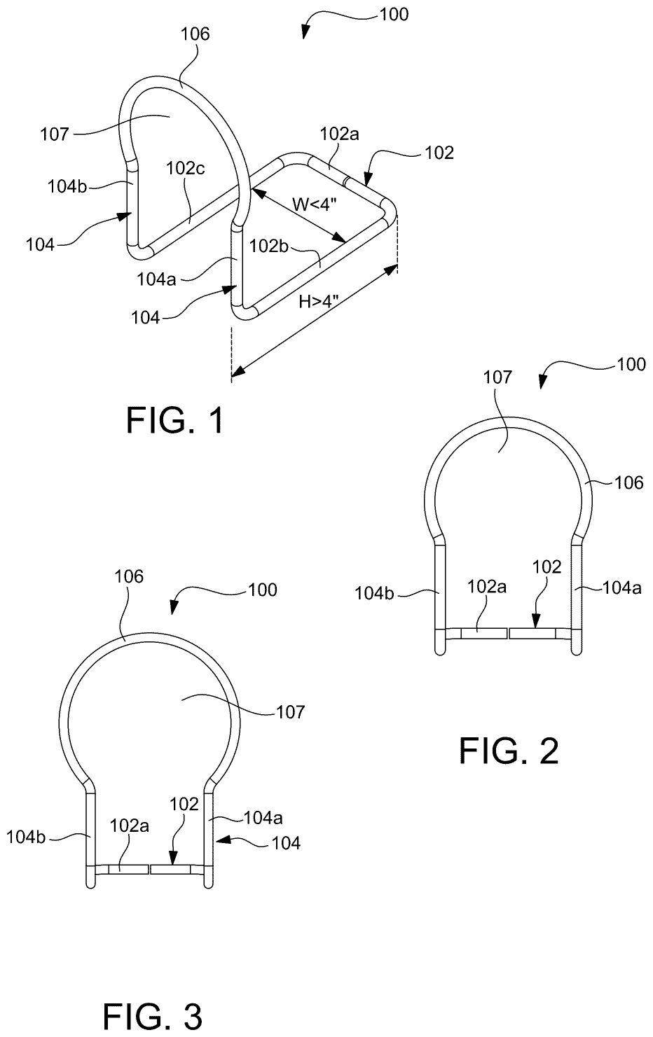

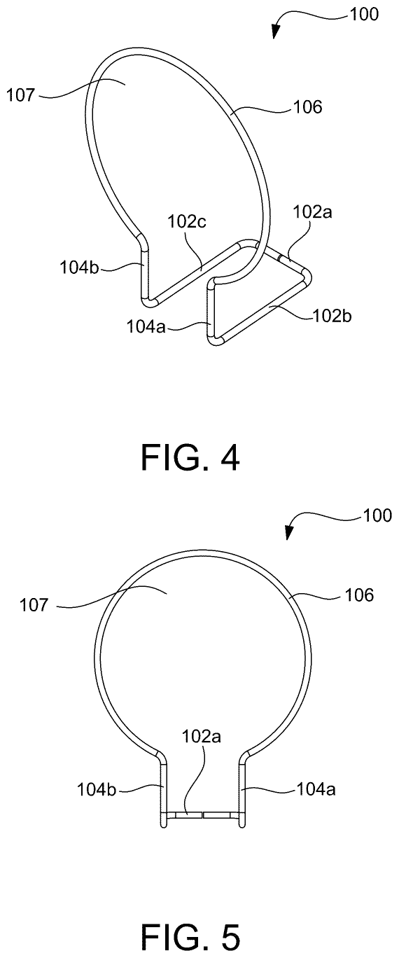

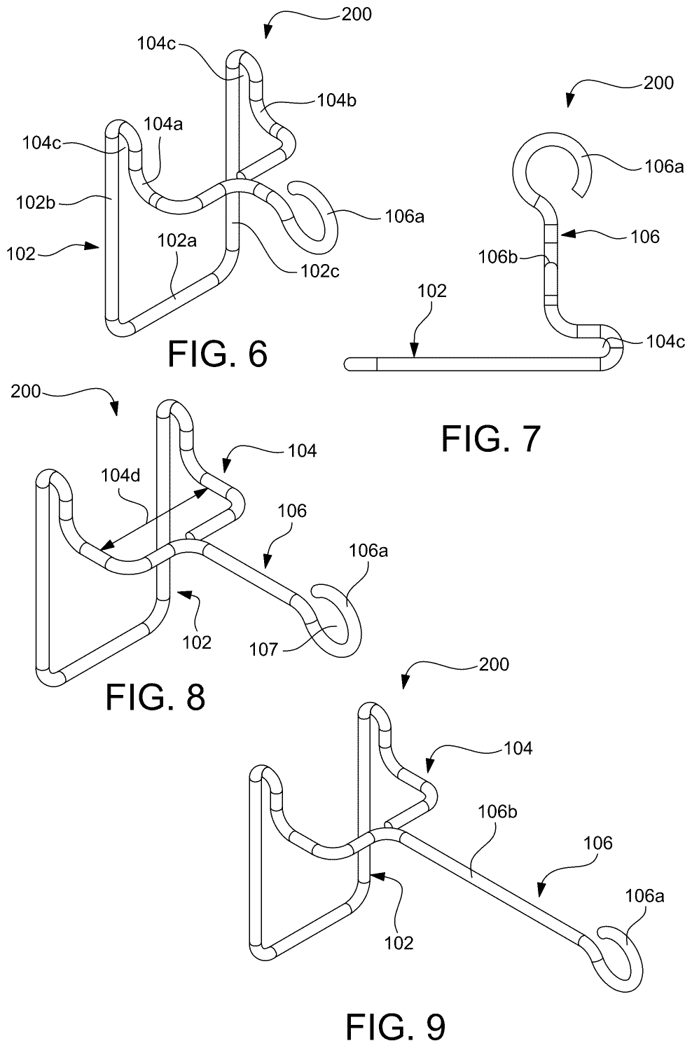

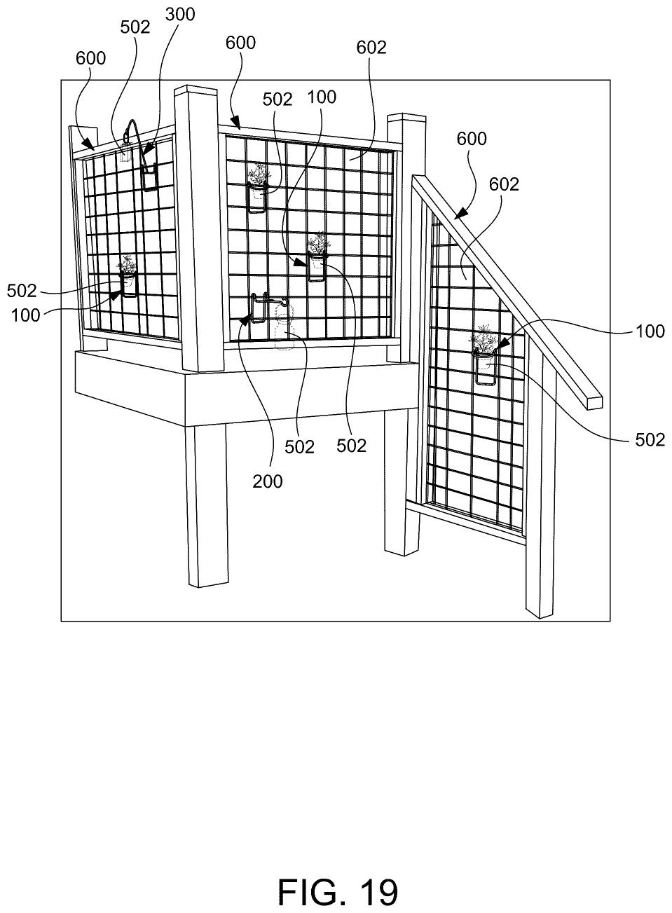

The hog wire hangers according to various embodiments and their uses with hog wire panels will now be described with reference to the accompanying drawings, particularly FIGS. 1-20.

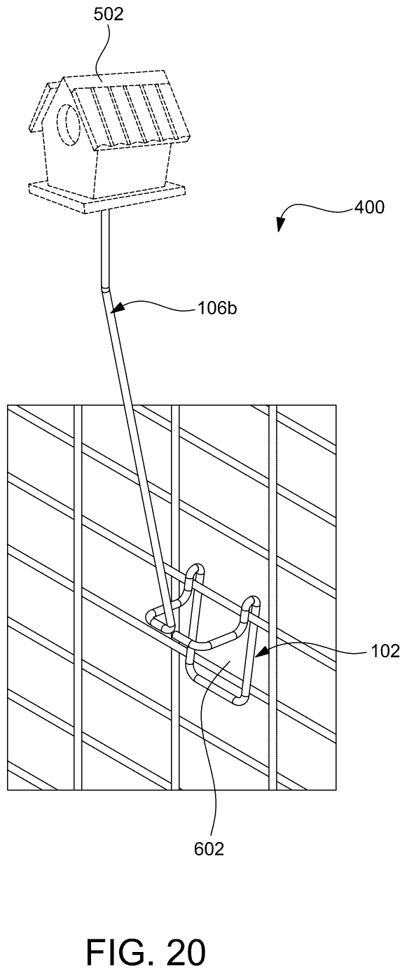

Referring to FIGS. 1-5, in conjunction with FIGS. 17-19, a hog wire hanger 100 is provided. Hereinafter the hog wire hanger 100 will be referred to as “hanger”. The hanger 100 includes an affixing portion 102. The affixing portion 102 fixes to a selected grid 602 of a hog wire panel 600 used in decks, stairways, or fences of the outdoor settings. The affixing portion 102 includes a base member 102a, a first vertical member 102b, and a second vertical member 102c upwardly extending from a first end, and a second end of the base member 102a. This gives substantially a U shape to the affixing portion 102. However, it should be understood that the affixing portion 102 may be configured in other shapes. For example, the base member 102b instead of being substantially straight, may be made curved or in some examples, the base member may be eliminated such that vertical members 102b, and 102c may interconnect each other at one end giving the affixing portion 102 a triangular shape.

The size of the base member 102a, and the vertical members 102b, and 102c of the affixing portion 102 is made such that the affixing portion 102 when fixed onto the selected grid 602 hooks and interlocks within the selected grid 602 as seen in FIGS. 17-19. The width (W) of the affixing portion 102 is made less than 4 inches and the height (H) of the affixing portion 102 is made greater than 4 inches if the affixing portion 102 is to be fixed to 4″×4″ grids of the hog wire panel 600. Likewise, the width (W) of the affixing portion 102 is made less than 6 inches and the height (H) of the affixing portion 102 is made greater than 6 inches if the affixing portion 102 is to be fixed to 6″×6″ grids of the hog wire panel 600. It should be understood and appreciated by those skilled in the art that, the width and the height of the affixing portion 102 can be customized based on the grids 602 sizes of the hog wire panels 600.

The hanger 100 further includes a pair of outwardly extending members 104a, 104b spaced apart from each other. The outwardly extending member 104a is extended from an end of the vertical member 102b, and the outwardly extending member 104b is extended from an end of the second vertical member 102c. In an embodiment, the outwardly extending members 104a, and 104b are extended substantially straight as shown in FIGS. 1-5.

The hanger 100 further includes a retaining portion 106 attached to an end of the outwardly extending member 104a and an end of the outwardly extending member 104b for retaining an outdoor décor 502 therein. According to the embodiment shown in FIGS. 1-5, the retaining portion 106 is circularly shaped. The retaining portion 106 defines a receiving space 107 for accommodating the outdoor décor 502 therein. The outdoor décor 205 in this embodiment is preferably a plant pot or planter. The size of the retaining portion 106 may be customized depending on the planter sizes. The receiving space 107 may be made in diameter ranging from 3.5 inches to 10.5 inches as seen in FIGS. 2, 3, and 5. According to the embodiment, the affixing portion 102 is oriented about 85 degrees in angle with respect to the outwardly extending members 104a, 104b. According to embodiments, the hanger 100 and associated components such as the affixing portion 102, the outwardly extending members 104a, 104b, and the retaining portion 106 made using steel wire that may be circular or square in cross-section, however, it is possible that other metallic or non-metallic rigid materials may be used and further color coating, rust free coatings, etc may be applied for enhancing aesthetics and durability of the hanger 100. The size of the hanger 100 is customizable to accommodate outdoor decors 502 such as planters of different sizes as should be appreciated by those skilled in the art.

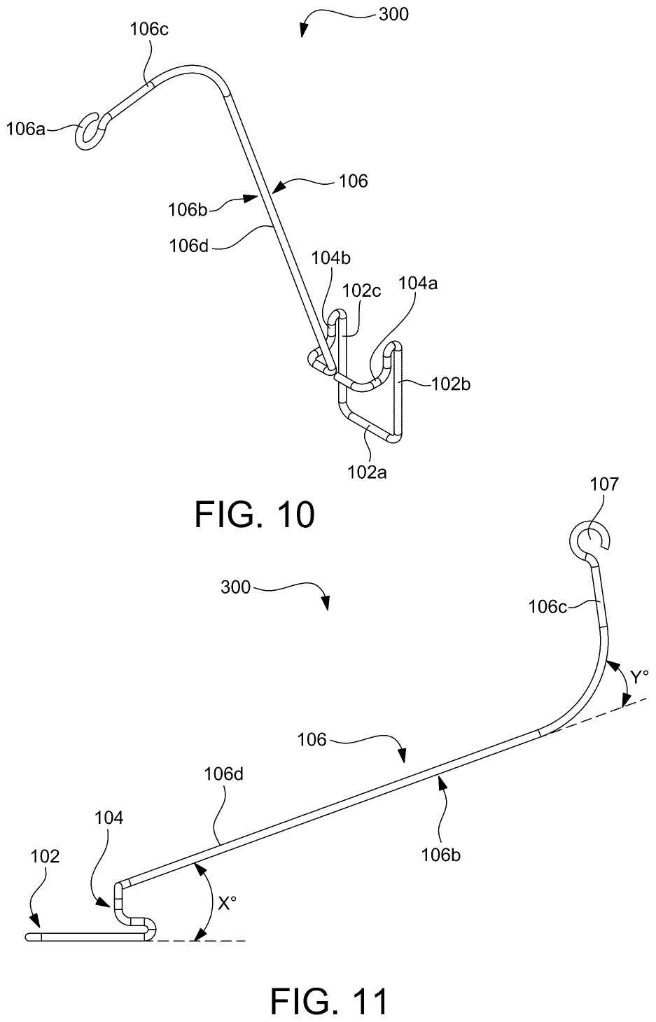

Referring to FIGS. 6-9, in conjunction with FIGS. 17-19, a hog wire hanger 200 is provided according to another embodiment. In this embodiment, the affixing portion 102 is similar to the affixing portion 102 described above with respect to FIGS. 1-5 and thus the description associated with the affixing portion 102 is omitted herein. The affixing portion 102 fixes to a selected grid 602 of the hog wire panel 600 commonly used in decks, stairways, or fences of the outdoor settings. However, in this embodiment, each of the outwardly extending members 104a,104b descends downward forming substantially U-shaped curves 104c extending from the members 104a, 104b before being extended outward from the ends of the vertical member 102b, and the vertical member 102c. The retaining portion 106 in this embodiment is configured as a hook member (106a, 106b). The hook member comprises a head 106a (E.g. C-shaped), and an arm 106b interconnected to the end of the first vertical member 102b, or the second vertical member 102c or interconnected to a U-shaped structure 104d. The outwardly extending members 104a, and 104b extends outward from the ends of the vertical members 102b,102c substantially forming the U-shaped structure (104d).

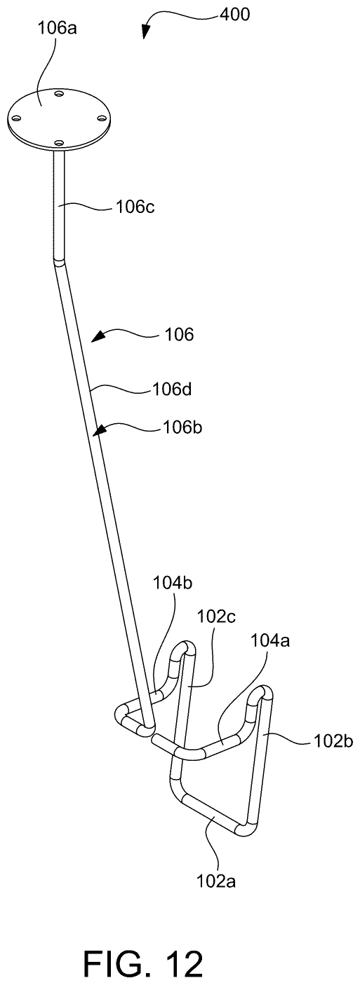

According to the embodiment, the C-shaped head 106a of the hook member defines the receiving space 107. The receiving space 107 is disposed of at a predefined distance from the affixing portion 102 for accommodating the outdoor décor 502 as shown in FIGS. 8-9. In an example, the predefined distance ranges from 3 inches to 9 inches. The arm 106b of the hook member is oriented substantially straight extending from the U-shaped structure104d and/or the outwardly extending members 104a,104b. The size of the hanger 200 is customizable to accommodate outdoor decors 502 such as lights, banners, lanterns, and others of different sizes as should be appreciated by those skilled in the art.

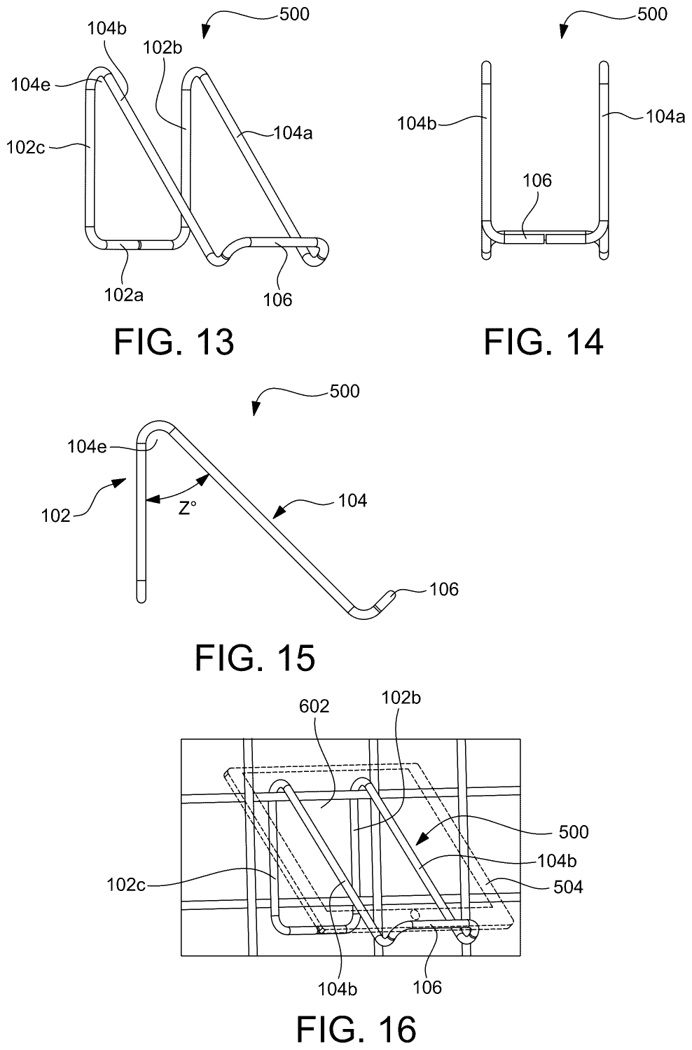

Referring to FIGS. 10-11, in conjunction with FIGS. 17-19, a hog wire hanger 300 is provided according to another embodiment. In this embodiment, the affixing portion 102 is similar to the affixing portion 102 described above with respect to FIGS. 1-5 and thus the description associated with the affixing portion 102 is omitted herein. This embodiment is similar to the embodiment shown and described with respect to FIGS. 6-9 with few notable design changes. In this particular embodiment, the arm 106b of the hook member is oriented at a first predefined angle (X degrees) from the affixing portion 102 extending from the U-shaped structure104d and/or the outwardly extending members 104a,104b. Further, a first portion 106 of the arm 106b having the C-shaped head 106a connected thereto is curved at a second predefined angle (Y degrees) with respect to a second portion of the arm 106d extending from the U-shaped structure 104d and/or the outwardly extending members 104a, 104b. In an example embodiment, the arm 106b of the hook member is oriented at about 20 degrees from the affixing portion 102 extending from the U-shaped structure 104d and/or the outwardly extending members 104a, 104b, and the first portion 106 of the arm 106b is curved at about 78 degrees with respect to the second portion of the arm 106d. The size of the hanger 300 is customizable to accommodate outdoor decors 502 such as lights, banners, lanterns, and others of different sizes as should be appreciated by those skilled in the art.

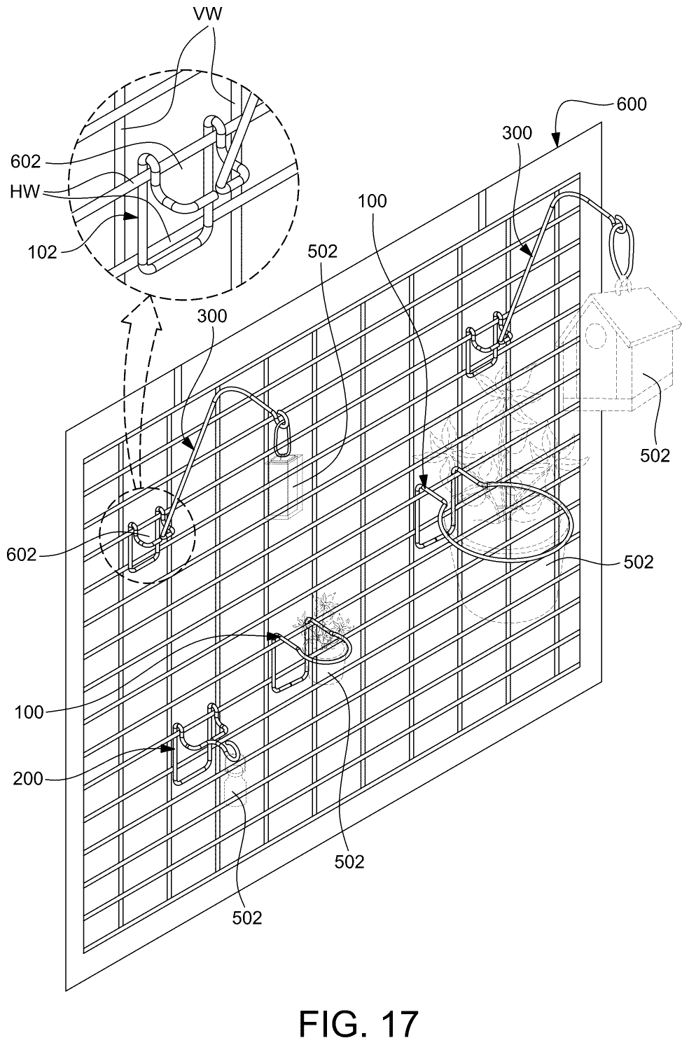

Referring to FIGS. 12 and 20, a hog wire hanger 400 is provided according to another embodiment. In this embodiment, the affixing portion 102 is similar to the affixing portion 102 described above with respect to FIGS. 1-5 and thus the description associated with the affixing portion 102 is omitted herein. This embodiment is similar to the embodiment shown and described with respect to FIGS. 10-11 with few notable design changes. Specifically, in this embodiment, the retaining portion 106 is configured as a mounting member, unlike the hook member. The mounting member of this embodiment includes a mount 106a for holding and supporting the outdoor décor 502. In an example, the mount 106a is useful for mounting bird houses as seen in FIG. 20 or it may be useful for mounting bird feeders, bird drinkers, etc. As seen, the arm (106b) in this embodiment is also interconnected to the end of the vertical member 102b and/or the second vertical member 102c or to the substantially U-shaped structure 104d. In this embodiment, the first portion 106c of the arm 106b having the mount 106a configured thereon is inwardly bent. The first portion 106c is inwardly bent at 90 degrees (being perpendicular) with respect to the mount 106a. The second portion 106d of the arm 106 is oriented at the first predefined angle (X degrees) from the affixing portion 102. In an example, the first predefined angle may be about 20 degrees. The size of the hanger 400 is customizable to accommodate bird houses, feeders, and so on of different sizes as should be appreciated by those skilled in the art.

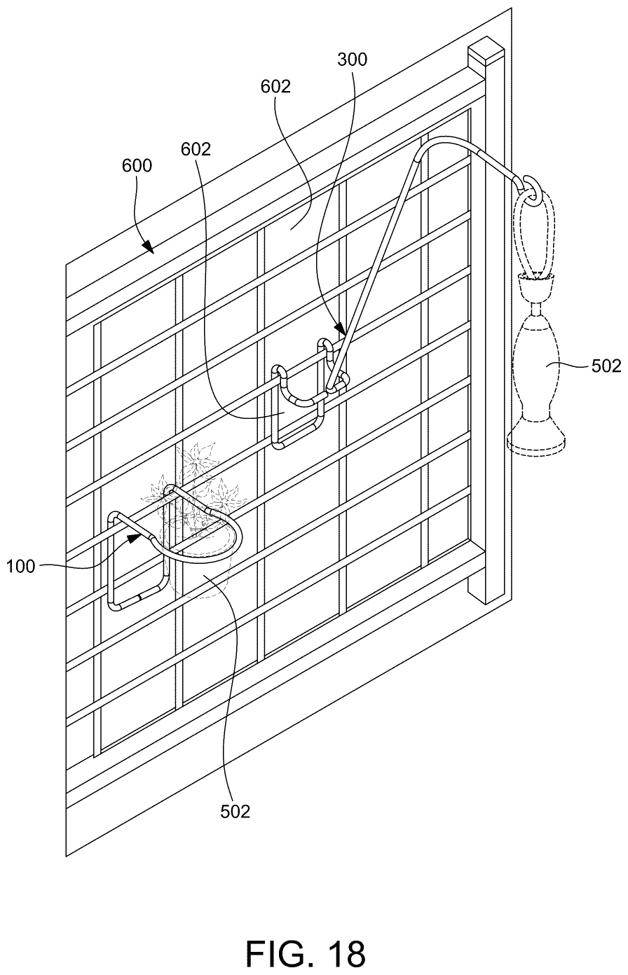

Referring to FIG. 13-16, a hog wire hanger 500 is provided according to yet another embodiment. In this embodiment, the affixing portion 102 is similar to the affixing portion 102 described above with respect to all the above-described embodiments, and thus the description associated with the affixing portion 102 is omitted herein. In this embodiment each of the outwardly extending members 104a, 104b descends downward at a third predefined angle (Z degrees) forming substantially V-shaped curves 104e with respect to the vertical members 102b, 102c before being extended outward from the end of the vertical members 102b, 102c. The predefined angle (Z degrees) is about 45 degrees.

In this embodiment, the retaining portion 106 is made substantially straight and connects the pair of outwardly extending members 104a, 104b. Further, the retaining portion 106 connects the outwardly extending members 104a, and 104b by being elevated by a certain distance (for example, 1 inch). According to the embodiment, the hanger 500 is configured to retain a mobile instrument 504 over the pair of outwardly extending members 104a, 104b. This embodiment of the hanger 500 is although configured for fixation onto the grids 602 of the hog wire panel 600. It should be understood that the hanger 500 shown in this embodiment may be mounted over a flat surface such as a table and may be used as a mobile instrument holder. The size of the hanger 500 is customizable to accommodate any size of the mobile instruments as should be understood by those skilled in the art.

Referring to FIGS. 17-19 that shows various hog wire hangers 100, 200, 300, and 400 of FIGS. 1,6,10, and 12 in use. Particularly, the FIGS. 17 and 18 show a hog wire panel 600 with grids 602. The hog wire panel 600 is any conventional type of hog panel used for outdoor uses such as in decks, stairways, fences around the backyard, and so on. FIG. 19 specifically shows a portion of the deck of a house having hog wire railing and stairways. Different hog wire hangers 100,200,300,400 described above with respect to the different embodiments are shown hung on the selected grids 602 of the hog panels 600. Attention is specifically drawn to FIG. 17 which showcases how the affixing portion 102 is interlocked in the selected grid 602 so that the hangers 100,200,300,400 do not disengage from the hog panel 600 during their uses. As specifically seen in the enlarged section of the hog panel in FIG. 17, the grid 602 is formed by a pair of horizontally running wires (HW), and a pair of vertically running wires (VW), and when the user intends to mount the hanger 300 on this specific grid 602, the user needs to insert the affixing portion 102 of the hanger 300 passing it from a top HW ensuring the base member surpasses a bottom HW and remain in resistive contact with the bottom HW. This mounting ensures that the affixing portion 102 of the hanger remains stable and fixed at its location without any movement. The term “resistive contact” in the context of the present disclosure means that the vertical members 102b, and 102c always remain in a situation where it is exerting force on the bottom HW while the hanger remains hung over the top HW (with the top HW within the U-shaped curves, V-shaped curves or at the point of contact between the vertical members 102b, 102c and the outwardly extending members 104a, 104b depending upon the embodiment of the hanger). The hangers 100,200,300,400 are specifically designed to support outdoor decors 502 over the hog panels. The outdoor decors include but are not limited to planters, bird houses, lights, banners, bird feeders, outdoor lanterns, and others on commonly used hog wire fencing, stairways, or deck railings. Further, certain embodiments of the proposed hog wire hangers may be useful for holding personal usable products such as mobile phones/tablets or other similar mobile instruments.

The various components of the embodiments of the hog wire hangers of the present invention are similar and interchangeable. It is obvious to the one skilled in the art that the various components, and parts of the hog wire of one embodiment of the present invention could be considered for other embodiments with little or no variation. Further, the material used for the construction of the hog wire hangers and various components may include any material such as but not limited to metal, rigid, wood, and so on.

It should be understood according to the preceding description of the present invention that the same is susceptible to changes, modifications, and adaptations, and that the said changes, modifications, and adaptations fall within the scope of the appended claims.

1. A hog wire hanger (100), comprising:
an affixing portion (102) adapted for detachably fixing at a selected grid (602) of a hog wire panel (600), wherein the affixing portion (102) consists of a base member (102a), a first vertical member (102b), and a second vertical member (102c) upwardly extending from a first end, and a second end of the base member (102a);
a pair of outwardly extending members (104a, 104b) spaced apart from each other, each of the outwardly extending members (104a,104b) extended from an end of the first vertical member (102b), and the second vertical member (102c) respectively; and
a retaining portion (106) attached to an end of the pair of outwardly extending members (104a, 104b) for retaining an outdoor décor (502) therein.

2. The hog wire hanger (100) of claim 1, wherein the retaining portion (106) is circular shaped defining a receiving space (107) for accommodating the outdoor décor (502) therein.

3. The hog wire hanger (100) of claim 1, wherein the receiving space (107) comprises a diameter ranging from 3.5 inches to 10.5 inches.

4. The hog wire hanger (100) of claim 1, wherein the affixing portion (102) is about 85 degrees in angle with respect to the pair of outwardly extending members (104a, 104b).

5. The hog wire hanger (100) of claim 1, wherein the affixing portion (102) is smaller than 4″ in width (W) and greater than 4″ in height (H) in order to be able to fix to 4″×4″ grid (602) of the hog wire panel (600).

6. The hog wire hanger (100) of claim 1, wherein each of the outwardly extending members (104a,104b) descends downward forming substantially U-shaped curves (104c) before being extended outward from the end of the first vertical member (102b), and the second vertical member (102c).

7. The hog wire hanger (100) of claim 1, wherein the retaining portion (106) is configured as a hook member comprising a C-shaped head (106a), and an arm (106b) interconnected to at least one of: the end of the first vertical member (102b), and the second vertical member (102c).

8. The hog wire hanger (100) of claim 1, wherein the pair of outwardly extending members (104a, 104b) extended outward from the end of the first vertical member (102b), and the second vertical member (102c) substantially forms a U-shaped structure (104d).

9. The hog wire hanger (100) of claim 7, the C-shaped head (106a) of the hook member defines the receiving space (107) disposed at a predefined distance from the affixing portion (102) for accommodating the outdoor décor (502).

10. The hog wire hanger (100) of claim 7, wherein the arm (106b) of the hook member is oriented substantially straight extending from the U-shaped structure (104d).

11. The hog wire hanger (100) of claim 7, wherein the arm (106b) of the hook member is oriented at a first predefined angle (X degrees) from the affixing portion (102) extending from the U-shaped structure (104d).

12. The hog wire hanger (100) of claim 11, wherein a first portion (106c) of the arm (106b) having the C-shaped head (106a) connected thereto is curved at a second predefined angle (Y degrees) with respect to a second portion of the arm (106d) extending from the U-shaped structure (104d).

13. The hog wire hanger (100) of claim 1, wherein the retaining portion (106) is configured as a mounting member comprising a mount (106a) for holding the outdoor décor (502), and the arm (106b) interconnected to at least one of: the end of the first vertical member (102b), and the second vertical member (102c).

14. The hog wire hanger (100) of claim 13, wherein the first portion (106c) of the arm (106b) having the mount (106a) configured thereon is inwardly bent and is oriented perpendicular to the mount (106a) while the second portion (106d) of the arm (106) is oriented at the first predefined angle (X degrees) from the affixing portion (102).

15. The hog wire hanger (100) of claim 1, wherein each of the outwardly extending members (104a,104b) descends downward at a third predefined angle (Z degrees) and forming substantially V-shaped curves (104d) before being extended outward from the end of the first vertical member (102b), and the second vertical member (102c).

16. The hog wire hanger (100) of claim 15, wherein the retaining portion (106) is made substantially straight and connects the pair of outwardly extending members (104a, 104b).

17. The hog wire hanger (100) of claim 16, wherein the retaining portion (106) connects the pair of outwardly extending members (104a, 104b) by being elevated by a certain distance.

18. The hog wire hanger (100) of claim 16, wherein the retaining portion (106) is configured to retain a mobile instrument (504) over the pair of outwardly extending members (104a, 104b).

19. The hog wire hanger (100) of claim 1, wherein the outdoor décor (502) is selected from a group of decors consisting of planters, bird houses, lights, banners, bird feeders, and lanterns.
